(19) United States
(12) Patent Application Publication
(10) Pub. No.: US 2026/0113088 A1
(43) Pub. Date: Apr. 23, 2026

(54) BEAMFORMING TRAINING FOR MILLIMETER WAVE OPERATION TRIGGERED FROM LOWER BAND WITH TRANSITION DELAY

(71) Applicant: Intel Corporation, Santa Clara, CA (US)

(72) Inventors: Cheng Chen, Camas, WA (US); Dmitry Akhmetov, Hillsboro, OR (US); Carlos Cordeiro, Portland, OR (US); Laurent Cariou, Milizac (FR)

(21) Appl. No.: 19/428,280

(22) Filed: Dec. 21, 2025

Related U.S. Application Data
(60) Provisional application No. 63/764,983, filed on Feb. 28, 2025.
(60) Provisional application No. 63/849,282, filed on Jul. 23, 2025.

(51) Int. Cl. H04B 7/06; H04L 5/00

(52) U.S. Cl. CPC H04B 7/0617; H04L 5/0048

(57) ABSTRACT

An access point multi-link device (AP MLD) configured for Integrated Millimeter Wave (IMMW) operation may decode a management frame received from a non-AP MLD that advertises a millimeter wave transition delay. The millimeter wave transition delay may be the amount of time for the non-AP MLD to transition from operating in a lower band (i.e., a sub 10 GHz band) to operating in an upper band (i.e., a millimeter wave band). The AP MLD may encode a Basic Beamforming Training (BBT) Announcement frame for transmission to the non-AP MLD in the lower band. The BBT Announcement frame may indicate a start time of a beamforming training phase for performing beamforming training in the upper band. The start time may be no earlier than an end of useful information carried in the BBT Announcement frame plus the millimeter wave transition delay. The AP MLD may also exchange BF Request and BF Response frames to negotiate whether to use Rx Sector Sweep BF mode or Tx Sector Sweep BF mode in the upcoming beamforming training phase with the non-AP MLD.

### RELATED APPLICATIONS

This application is related to U.S. Provisional Patent Application Ser. No. 18/870,436, filed Nov. 28, 2024 [reference number AE1975-PCT-US], U.S. Provisional Patent Application Ser. No. 17/561,758 filed Dec. 24, 2021 [reference number AD7692-US] and U.S. Provisional Patent Application Ser. No. 18/842,838 filed Aug. 30, 2024 [reference number AE0356-PCT-US].

### PRIORITY CLAIMS

This application claims priority under 35 USC 119(e) to U.S. Provisional Patent Application Ser. No. 63/764,983, filed Feb. 28, 2025 [reference number AG4047-Z] and U.S. Provisional Patent Application Ser. No. 63/849,282, filed Jul. 23, 2025 [reference number AG4927-Z] which are incorporated herein by reference in its entireties.

### TECHNICAL FIELD

Embodiments pertain to wireless communications. Some embodiments relate wireless local area network (WLAN) operation at millimeter wave frequencies.

### BACKGROUND

Millimeter wave (mmWave) operation in WLANs offers several key advantages. The mmWave bands (typically 30-300 GHz, with 60 GHz being common for WLANs) provide much wider channels and more unlicensed spectrum compared to the crowded 2.4 GHz and 5 GHz bands. This enables multi-gigabit data rates. The wide bandwidths available (channels can be 2+ GHz wide) allow for extremely high data rates, reaching 10+ Gbps. This supports bandwidth-intensive applications like uncompressed 4K/8K video streaming, VR/AR, and fast file transfers. Another advantage to millimeter wave operation is the small antenna size. The short wavelengths allow for compact antenna arrays and beamforming implementations, making it feasible to integrate sophisticated MIMO systems into relatively small devices.

One issue with operation at millimeter wave frequencies is the higher path loss compared to operation as lower frequencies, (e.g., microwave frequencies). To help address this higher path loss, beamforming is performed. Beamforming concentrates radio energy into narrow, focused beams rather than broadcasting omnidirectionally, which compensates for this path loss by increasing the effective signal strength in specific directions. Beamforming training is the process by which transmit and receive antennas learn the optimal beam directions to help maximize signal quality and throughput.

Another issue with operation at millimeter wave frequencies is the time for a device to transition from operation at a lower frequency band to operation at a millimeter wave band.

### BRIEF DESCRIPTION OF THE DRAWINGS

The present disclosure is illustrated by way of example and not limitation in the figures of the accompanying drawings, in which like references indicate similar elements and in which:

FIG. 1 is a block diagram of a radio architecture in accordance with some embodiments.

FIG. 2 illustrates a front-end module circuitry for use in the radio architecture of FIG. 1 in accordance with some embodiments.

FIG. 3 illustrates a radio IC circuitry for use in the radio architecture of FIG. 1 in accordance with some embodiments.

FIG. 4 illustrates a baseband processing circuitry for use in the radio architecture of FIG. 1 in accordance with some embodiments.

FIG. 5 illustrates a WLAN in accordance with some embodiments.

FIG. 6 illustrates a block diagram of an example machine upon which any one or more of the techniques (e.g., methodologies) discussed herein may perform.

FIG. 7 illustrates a block diagram of an example wireless device upon which any one or more of the techniques (e.g., methodologies or operations) discussed herein may perform.

FIG. 8 illustrates multi-link devices (MLDs), in accordance with some embodiments.

FIG. 9A illustrates Beamforming Training (Mode 1) for millimeter wave operation, in accordance with some embodiments.

FIG. 9B illustrates Beamforming Training (Mode 2) for millimeter wave operation, in accordance with some embodiments.

FIG. 10A illustrates a sequence with channel access right before Phase 2, in accordance with some embodiments.

FIG. 10B illustrates a sequence with channel access right before Phase 2 with ability to have backoff stay at zero until the start of phase 2 to align with start time, in accordance with some embodiments.

FIG. 10C illustrates a sequence with joint channel access at a lower band and at millimeter wave band and transmission of basic beamforming training (BBT) announcement on both links to occupy the medium at millimeter wave band and ensure alignment of phase 2 start time, in accordance with some embodiments.

FIG. 10D illustrates a sequence with channel access at millimeter wave band ahead of time and transmission of CTS-to-self or other frame to occupy the medium at millimeter wave band and ensure alignment of phase 2 start time in accordance with some embodiments.

FIG. 11A illustrates a beamforming training sequence for an Rx Sector Sweep, in accordance with some embodiments.

FIG. 11B illustrates a beamforming training sequence for a Tx Sector Sweep, in accordance with some embodiments.

### DETAILED DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

Currently the Wi-Fi ecosystem has lower band technologies (e.g., sub 10 GHz technologies used in IEEE standards and draft standards such as IEEE 802.11n/.11ac/.11ax/.11be) and the upper band technologies (i.e., millimeter wave technology used in IEEE standards and draft standards such as IEEE 802.11ad/.11ay). These standards have little commonality and were designed to operate, in large part, independently. In Wi-Fi 8, a large part of the design may be reused in the lower band and bring it to the upper band. In addition, it is desirable to have the two bands operate seamlessly under single control using the multi-link protocol and concepts developed largely in Wi-Fi 7. In the previous versions of the standards, there was no way to operate both under one controller and easily exchange information. Embodiments disclosed herein will add more reliability to both links, especially for upper band links where links are harder to establish and maintain with any movement.

The Integrated Millimeter Wave (IMMW) Task Group 802.11bq is a standard task group that aims to define integrated mmWave operation in Wi-Fi. Different from previous mmWave Wi-Fi standard, namely, IEEE 802.11ad and 802.11ay, IMMW intends to build the general Wi-Fi operation at mmWave bands on top of existing PHY and MAC defined in the lower bands. Different from the lower band links, an mmWave link typically needs beamforming to close. The conventional beamforming techniques of IEEE 802.11ad and 802.11ay are complex and difficult to perform. Thus, what is needed are improved techniques for establishing and maintaining millimeter wave links while taking advantage of lower band link availability.

Some embodiments disclosed herein are directed to improved beamforming procedures. In these embodiments, referred to as Tx sector sweep embodiments, a BF initiator first sweeps through all of its Tx Sectors while the BF responder's Rx Sectors are frozen. These embodiments allow the BF initiator and BF responder to negotiate and determine whether to use a Tx Sector Sweep or a Rx Sector Sweep in the BF training sequence. Furthermore, additional feedback information other than best TX/RX sector combination may be provided. These embodiments, as well as others, are described in more detail below.

Additional embodiments disclosed herein expand current lower band operation to the upper band. This would be operationally different than what is defined in the upper band standards. There are several enablers that make this more viable, and likely others in the ecosystem, than in the past. For example, cost reduction through reuse of existing architecture, with targets to reuse as much as possible the same baseband for a Wi-Fi and a millimeter wave radio. With less new bandwidth opening in the lower bands there is less potential for throughput enhancements. A multi-link framework makes operation on multiple links easier allows the design to compensate for the fragility of the link at millimeter wave bands through providing a path to easily fall back to lower band operation.

Initial design of Beamforming Training for millimeter wave operation allows two stations to train their analog smart antennas and determine the best sector to use to point in the direction of each other both for transmit and receive directions. In this approach, the initiator transmits training symbols or training frames multiple times using different sectors (i.e., sector sweeping). The receiver may also perform a receive sector sweep and in the other station will receive the training frame in omni receive mode and will simply measure RSSI for the frames that detects. These embodiments are described in more detail below.

In some embodiments, an access point multi-link device (AP MLD) configured for Integrated Millimeter Wave (IMMW) operation may decode a management frame received from a non-AP MLD that advertises a millimeter wave transition delay. The millimeter wave transition delay may be the amount of time for the non-AP MLD to transition from operating in a lower band (i.e., a sub 10 GHz band) to operating in an upper band (i.e., a millimeter wave band). The AP MLD may encode a Basic Beamforming Training (BBT) Announcement frame for transmission to the non-AP MLD in the lower band. The BBT Announcement frame may indicate a start time of a beamforming training phase for performing beamforming training in the upper band. The start time may be no earlier than an end of useful information carried in the BBT Announcement frame plus the millimeter wave transition delay. The AP MLD may also exchange BF Request and BF Response frames to negotiate whether to use Rx Sector Sweep BF mode or Tx Sector Sweep BF mode in the upcoming beamforming training phase with the non-AP MLD. These embodiments are described in more detail below.

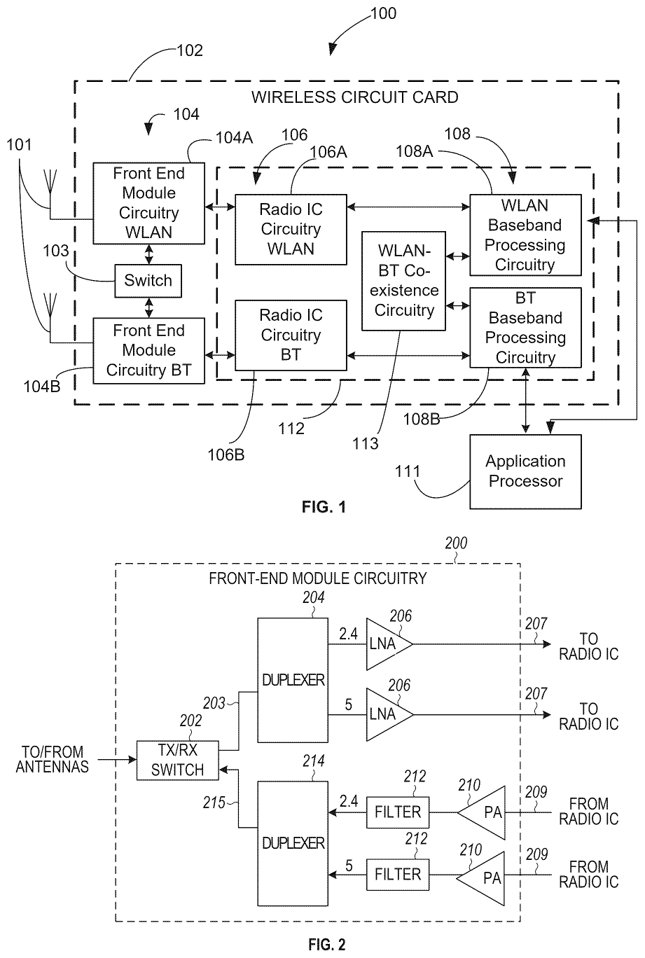

FIG. 1 is a block diagram of a radio architecture 100 in accordance with some embodiments. Radio architecture 100 may include radio front-end module (FEM) circuitry 104, radio IC circuitry 106 and baseband processing circuitry 108. Radio architecture 100 as shown includes both Wireless Local Area Network (WLAN) functionality and Bluetooth (BT) functionality although embodiments are not so limited. In this disclosure, “WLAN”and “Wi-Fi”are used interchangeably.

FEM circuitry 104 may include a WLAN or Wi-Fi FEM circuitry 104A and a Bluetooth (BT) FEM circuitry 104B. The WLAN FEM circuitry 104A may include a receive signal path comprising circuitry configured to operate on WLAN RF signals received from one or more antennas 101, to amplify the received signals and to provide the amplified versions of the received signals to the WLAN radio IC circuitry 106A for further processing. The BT FEM circuitry 104B may include a receive signal path which may include circuitry configured to operate on BT RF signals received from one or more antennas 101, to amplify the received signals and to provide the amplified versions of the received signals to the BT radio IC circuitry 106B for further processing. FEM circuitry 104A may also include a transmit signal path which may include circuitry configured to amplify WLAN signals provided by the radio IC circuitry 106A for wireless transmission by one or more of the antennas 101. In addition, FEM circuitry 104B may also include a transmit signal path which may include circuitry configured to amplify BT signals provided by the radio IC circuitry 106B for wireless transmission by the one or more antennas. In the embodiment of FIG. 1, although FEM circuitry 104A and FEM circuitry 104B are shown as being distinct from one another, embodiments are not so limited, and include within their scope the use of an FEM (not shown) that includes a transmit path and/or a receive path for both WLAN and BT signals, or the use of one or more FEM circuitries where at least some of the FEM circuitries share transmit and/or receive signal paths for both WLAN and BT signals. In some embodiments, FEM circuitry 104A may include transceiver circuitry for operating in sub 10 GHz bands as well as transceiver circuitry for operating in millimeter wave bands.

Radio IC circuitry 106 as shown may include WLAN radio IC circuitry 106A and BT radio IC circuitry 106B. The WLAN radio IC circuitry 106A may include a receive signal path which may include circuitry to down-convert WLAN RF signals received from the FEM circuitry 104A and provide baseband signals to WLAN baseband processing circuitry 108A. BT radio IC circuitry 106B may in turn include a receive signal path which may include circuitry to down-convert BT RF signals received from the FEM circuitry 104B and provide baseband signals to BT baseband processing circuitry 108B. WLAN radio IC circuitry 106A may also include a transmit signal path which may include circuitry to up-convert WLAN baseband signals provided by the WLAN baseband processing circuitry 108A and provide WLAN RF output signals to the FEM circuitry 104A for subsequent wireless transmission by the one or more antennas 101. BT radio IC circuitry 106B may also include a transmit signal path which may include circuitry to up-convert BT baseband signals provided by the BT baseband processing circuitry 108B and provide BT RF output signals to the FEM circuitry 104B for subsequent wireless transmission by the one or more antennas 101. In the embodiment of FIG. 1, although radio IC circuitries 106A and 106B are shown as being distinct from one another, embodiments are not so limited, and include within their scope the use of a radio IC circuitry (not shown) that includes a transmit signal path and/or a receive signal path for both WLAN and BT signals, or the use of one or more radio IC circuitries where at least some of the radio IC circuitries share transmit and/or receive signal paths for both WLAN and BT signals.

Baseband processing circuity 108 may include a WLAN baseband processing circuitry 108A and a BT baseband processing circuitry 108B. The WLAN baseband processing circuitry 108A may include a memory, such as, for example, a set of RAM arrays in a Fast Fourier Transform or Inverse Fast Fourier Transform block (not shown) of the WLAN baseband processing circuitry 108A. Each of the WLAN baseband circuitry 108A and the BT baseband circuitry 108B may further include one or more processors and control logic to process the signals received from the corresponding WLAN or BT receive signal path of the radio IC circuitry 106, and to also generate corresponding WLAN or BT baseband signals for the transmit signal path of the radio IC circuitry 106. Each of the baseband processing circuitries 108A and 108B may further include physical layer (PHY) and medium access control layer (MAC) circuitry and may further interface with application processor 111 for generation and processing of the baseband signals and for controlling operations of the radio IC circuitry 106.

Referring still to FIG. 1, according to the shown embodiment, WLAN-BT coexistence circuitry 113 may include logic providing an interface between the WLAN baseband circuitry 108A and the BT baseband circuitry 108B to enable use cases requiring WLAN and BT coexistence. In addition, a switch 103 may be provided between the WLAN FEM circuitry 104A and the BT FEM circuitry 104B to allow switching between the WLAN and BT radios according to application needs. In addition, although the antennas 101 are depicted as being respectively connected to the WLAN FEM circuitry 104A and the BT FEM circuitry 104B, embodiments include within their scope the sharing of one or more antennas as between the WLAN and BT Femsa, or the provision of more than one antenna connected to each of FEM circuitry 104A or FEM circuitry 104B.

In some embodiments, the front-end module circuitry 104, the radio IC circuitry 106, and baseband processing circuitry 108 may be provided on a single radio card, such as wireless radio card 102. In some other embodiments, the one or more antennas 101, the FEM circuitry 104 and the radio IC circuitry 106 may be provided on a single radio card. In some other embodiments, the radio IC circuitry 106 and the baseband processing circuitry 108 may be provided on a single chip or IC, such as IC 112.

In some embodiments, the wireless radio card 102 may include a WLAN radio card and may be configured for Wi-Fi communications, although the scope of the embodiments is not limited in this respect. In some of these embodiments, the radio architecture 100 may be configured to receive and transmit orthogonal frequency division multiplexed (OFDM) or orthogonal frequency division multiple access (OFDMA) communication signals over a multicarrier communication channel. The OFDM or OFDMA signals may comprise a plurality of orthogonal subcarriers.

In some of these multicarrier embodiments, radio architecture 100 may be part of a Wi-Fi communication station (STA) such as a wireless access point (AP), a base station or a mobile device including a Wi-Fi device. In some of these embodiments, radio architecture 100 may be configured to transmit and receive signals in accordance with specific communication standards and/or protocols, such as any of the Institute of Electrical and Electronics Engineers (IEEE) standards including, IEEE 802.11n-2009, IEEE 802.11-2012, IEEE 802.11-2016, IEEE 802.11ac, and/or IEEE 802.11ax standards and/or proposed specifications for WLANs, although the scope of embodiments is not limited in this respect. Radio architecture 100 may also be suitable to transmit and/or receive communications in accordance with other techniques and standards.

In some embodiments, the radio architecture 100 may be configured for high-efficiency (HE) Wi-Fi (HEW) communications in accordance with the IEEE 802.11ax standard. In these embodiments, the radio architecture 100 may be configured to communicate in accordance with an OFDMA technique, although the scope of the embodiments is not limited in this respect.

In some other embodiments, the radio architecture 100 may be configured to transmit and receive signals transmitted using one or more other modulation techniques such as spread spectrum modulation (e.g., direct sequence code division multiple access (DS-CDMA) and/or frequency hopping code division multiple access (FH-CDMA)), time-division multiplexing (TDM) modulation, and/or frequency-division multiplexing (FDMA) modulation, although the scope of the embodiments is not limited in this respect.

In some embodiments, as further shown in FIG. 1, the BT baseband circuitry 108B may be compliant with a Bluetooth (BT) connectivity standard such as Bluetooth, Bluetooth 4.0 or Bluetooth 5.0, or any other iteration of the Bluetooth Standard. In embodiments that include BT functionality as shown for example in FIG. 1, the radio architecture 100 may be configured to establish a BT synchronous connection oriented (SCO) link and/or a BT low energy (BT LE) link. In some of the embodiments that include functionality, the radio architecture 100 may be configured to establish an extended SCO (eSCO) link for BT communications, although the scope of the embodiments is not limited in this respect. In some of these embodiments that include a BT functionality, the radio architecture may be configured to engage in a BT Asynchronous Connection-Less (ACL) communications, although the scope of the embodiments is not limited in this respect. In some embodiments, as shown in FIG. 1, the functions of a BT radio card and WLAN radio card may be combined on a single wireless radio card, such as single wireless radio card 102, although embodiments are not so limited, and include within their scope discrete WLAN and BT radio cards

In some embodiments, the radio architecture 100 may include other radio cards, such as a cellular radio card configured for cellular (e.g., 3GPP such as LTE, LTE-Advanced or 5G communications).

In some IEEE 802.11 embodiments, the radio architecture 100 may be configured for communication over various channel bandwidths including bandwidths having center frequencies of about 900 MHz, 2.4 GHz, 5 GHz, and bandwidths of about 1 MHz, 2 MHz, 2.5 MHz, 4 MHz, 5 MHz, 8 MHz, 10 MHz, 16 MHz, 20 MHz, 40 MHz, 80 MHz (with contiguous bandwidths) or 80+80 MHz (160 MHz) (with non-contiguous bandwidths). In some embodiments, a 320 MHz channel bandwidth may be used. The scope of the embodiments is not limited with respect to the above center frequencies, however.

FIG. 2 illustrates FEM circuitry 200 in accordance with some embodiments. The FEM circuitry 200 is one example of circuitry that may be suitable for use as the WLAN and/or BT FEM circuitry 104A/104B (FIG. 1), although other circuitry configurations may also be suitable.

In some embodiments, the FEM circuitry 200 may include a TX/RX switch 202 to switch between transmit mode and receive mode operation. The FEM circuitry 200 may include a receive signal path and a transmit signal path. The receive signal path of the FEM circuitry 200 may include a low-noise amplifier (LNA) 206 to amplify received RF signals 203 and provide the amplified received RF signals 207 as an output (e.g., to the radio IC circuitry 106 (FIG. 1)). The transmit signal path of the circuitry 200 may include a power amplifier (PA) to amplify input RF signals 209 (e.g., provided by the radio IC circuitry 106), and one or more filters 212, such as band-pass filters (BPFs), low-pass filters (LPFs) or other types of filters, to generate RF signals 215 for subsequent transmission (e.g., by one or more of the antennas 101 (FIG. 1)).

In some dual-mode embodiments for Wi-Fi communication, the FEM circuitry 200 may be configured to operate in either the 2.4 GHz frequency spectrum or the 5 GHz frequency spectrum. In these embodiments, the receive signal path of the FEM circuitry 200 may include a receive signal path duplexer 204 to separate the signals from each spectrum as well as provide a separate LNA 206 for each spectrum as shown. In these embodiments, the transmit signal path of the FEM circuitry 200 may also include a power amplifier 210 and a filter 212, such as a BPF, a LPF or another type of filter for each frequency spectrum and a transmit signal path duplexer 214 to provide the signals of one of the different spectrums onto a single transmit path for subsequent transmission by the one or more of the antennas 101 (FIG. 1). In some embodiments, BT communications may utilize the 2.4 GHZ signal paths and may utilize the same FEM circuitry 200 as the one used for WLAN communications.

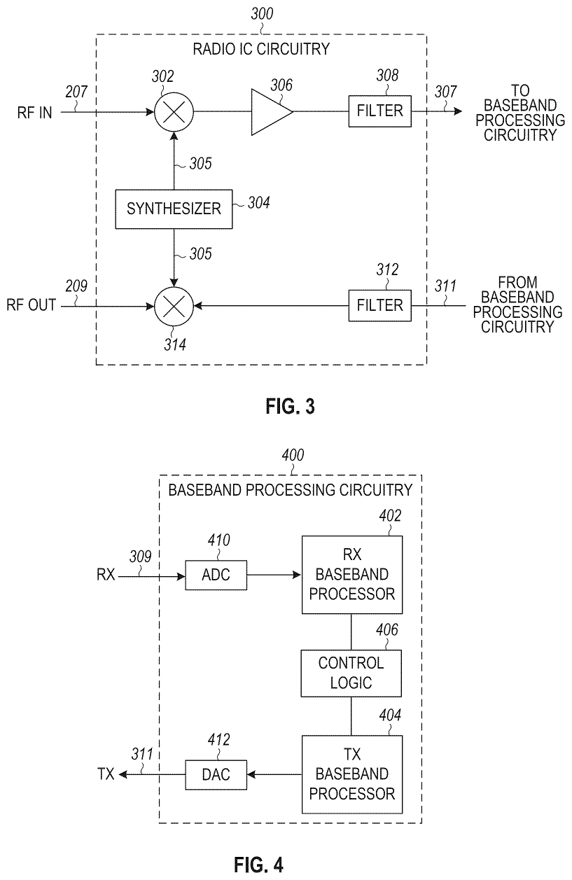

FIG. 3 illustrates radio integrated circuit (IC) circuitry 300 in accordance with some embodiments. The radio IC circuitry 300 is one example of circuitry that may be suitable for use as the WLAN or BT radio IC circuitry 106A/106B (FIG. 1), although other circuitry configurations may also be suitable.

In some embodiments, the radio IC circuitry 300 may include a receive signal path and a transmit signal path. The receive signal path of the radio IC circuitry 300 may include at least mixer circuitry 302, such as, for example, down-conversion mixer circuitry, amplifier circuitry 306 and filter circuitry 308. The transmit signal path of the radio IC circuitry 300 may include at least filter circuitry 312 and mixer circuitry 314, such as, for example, up-conversion mixer circuitry.

Radio IC circuitry 300 may also include synthesizer circuitry 304 for synthesizing a frequency 305 for use by the mixer circuitry 302 and the mixer circuitry 314. The mixer circuitry 302 and/or 314 may each, according to some embodiments, be configured to provide direct conversion functionality. The latter type of circuitry presents a much simpler architecture as compared with standard super-heterodyne mixer circuitries, and any flicker noise brought about by the same may be alleviated, for example through the use of OFDM modulation. FIG. 3 illustrates only a simplified version of a radio IC circuitry, and may include, although not shown, embodiments where each of the depicted circuitries may include more than one component. For instance, mixer circuitry 320 and/or 314 may each include one or more mixers, and filter circuitries 308 and/or 312 may each include one or more filters, such as one or more BPFs and/or LPFs according to application needs. For example, when mixer circuitries are of the direct-conversion type, they may each include two or more mixers.

In some embodiments, mixer circuitry 302 may be configured to down-convert RF signals 207 received from the FEM circuitry 104 (FIG. 1) based on the synthesized frequency 305 provided by synthesizer circuitry 304. The amplifier circuitry 306 may be configured to amplify the down-converted signals and the filter circuitry 308 may include a LPF configured to remove unwanted signals from the down-converted signals to generate output baseband signals 307. Output baseband signals 307 may be provided to the baseband processing circuitry 108 (FIG. 1) for further processing. In some embodiments, the output baseband signals 307 may be zero-frequency baseband signals, although this is not a requirement. In some embodiments, mixer circuitry 302 may comprise passive mixers, although the scope of the embodiments is not limited in this respect.

In some embodiments, the mixer circuitry 314 may be configured to up-convert input baseband signals 311 based on the synthesized frequency 305 provided by the synthesizer circuitry 304 to generate RF output signals 209 for the FEM circuitry 104. The baseband signals 311 may be provided by the baseband processing circuitry 108 and may be filtered by filter circuitry 312. The filter circuitry 312 may include a LPF or a BPF, although the scope of the embodiments is not limited in this respect.

In some embodiments, the mixer circuitry 302 and the mixer circuitry 314 may each include two or more mixers and may be arranged for quadrature down-conversion and/or up-conversion respectively with the help of synthesizer circuitry 304. In some embodiments, the mixer circuitry 302 and the mixer circuitry 314 may each include two or more mixers each configured for image rejection (e.g., Hartley image rejection). In some embodiments, the mixer circuitry 302 and the mixer circuitry 314 may be arranged for direct down-conversion and/or direct up-conversion, respectively. In some embodiments, the mixer circuitry 302 and the mixer circuitry 314 may be configured for super-heterodyne operation, although this is not a requirement.

Mixer circuitry 302 may comprise, according to one embodiment: quadrature passive mixers (e.g., for the in-phase (I) and quadrature phase (Q) paths). In such an embodiment, RF input signal 207 from FIG. 3 may be down-converted to provide I and Q baseband output signals to be sent to the baseband processor

Quadrature passive mixers may be driven by zero and ninety-degree time-varying LO switching signals provided by a quadrature circuitry which may be configured to receive a LO frequency (f_{LO}) from a local oscillator or a synthesizer, such as LO frequency 305 of synthesizer circuitry 304 (FIG. 3). In some embodiments, the LO frequency may be the carrier frequency, while in other embodiments, the LO frequency may be a fraction of the carrier frequency (e.g., one-half the carrier frequency, one-third the carrier frequency). In some embodiments, the zero and ninety-degree time-varying switching signals may be generated by the synthesizer, although the scope of the embodiments is not limited in this respect.

In some embodiments, the LO signals may differ in duty cycle (the percentage of one period in which the LO signal is high) and/or offset (the difference between start points of the period). In some embodiments, the LO signals may have a 25% duty cycle and a 50% offset. In some embodiments, each branch of the mixer circuitry (e.g., the in-phase (I) and quadrature phase (Q) path) may operate at a 25% duty cycle, which may result in a significant reduction in power consumption.

The RF input signal 207 (FIG. 2) may comprise a balanced signal, although the scope of the embodiments is not limited in this respect. The I and Q baseband output signals may be provided to low-nose amplifier, such as amplifier circuitry 306 (FIG. 3) or to filter circuitry 308 (FIG. 3).

In some embodiments, the output baseband signals 307 and the input baseband signals 311 may be analog baseband signals, although the scope of the embodiments is not limited in this respect. In some alternate embodiments, the output baseband signals 307 and the input baseband signals 311 may be digital baseband signals. In these alternate embodiments, the radio IC circuitry may include analog-to-digital converter (ADC) and digital-to-analog converter (DAC) circuitry.

In some dual-mode embodiments, a separate radio IC circuitry may be provided for processing signals for each spectrum, or for other spectrums not mentioned here, although the scope of the embodiments is not limited in this respect.

In some embodiments, the synthesizer circuitry 304 may be a fractional-N synthesizer or a fractional N/N+1 synthesizer, although the scope of the embodiments is not limited in this respect as other types of frequency synthesizers may be suitable. For example, synthesizer circuitry 304 may be a delta-sigma synthesizer, a frequency multiplier, or a synthesizer comprising a phase-locked loop with a frequency divider. According to some embodiments, the synthesizer circuitry 304 may include digital synthesizer circuitry. An advantage of using a digital synthesizer circuitry is that, although it may still include some analog components, its footprint may be scaled down much more than the footprint of an analog synthesizer circuitry. In some embodiments, frequency input into synthesizer circuity 304 may be provided by a voltage controlled oscillator (VCO), although that is not a requirement. A divider control input may further be provided by either the baseband processing circuitry 108 (FIG. 1) or the application processor 111 (FIG. 1) depending on the desired output frequency 305. In some embodiments, a divider control input (e.g., N) may be determined from a look-up table (e.g., within a Wi-Fi card) based on a channel number and a channel center frequency as determined or indicated by the application processor 111.

In some embodiments, synthesizer circuitry 304 may be configured to generate a carrier frequency as the output frequency 305, while in other embodiments, the output frequency 305 may be a fraction of the carrier frequency (e.g., one-half the carrier frequency, one-third the carrier frequency). In some embodiments, the output frequency 305 may be a LO frequency (f_{LO}).

FIG. 4 illustrates a functional block diagram of baseband processing circuitry 400 in accordance with some embodiments. The baseband processing circuitry 400 is one example of circuitry that may be suitable for use as the baseband processing circuitry 108 (FIG. 1), although other circuitry configurations may also be suitable. The baseband processing circuitry 400 may include a receive baseband processor (RX BBP) 402 for processing receive baseband signals 309 provided by the radio IC circuitry 106 (FIG. 1) and a transmit baseband processor (TX BBP) 404 for generating transmit baseband signals 311 for the radio IC circuitry 106. The baseband processing circuitry 400 may also include control logic 406 for coordinating the operations of the baseband processing circuitry 400.

In some embodiments (e.g., when analog baseband signals are exchanged between the baseband processing circuitry 400 and the radio IC circuitry 106), the baseband processing circuitry 400 may include ADC 410 to convert analog baseband signals received from the radio IC circuitry 106 to digital baseband signals for processing by the receive baseband processor 402. In these embodiments, the baseband processing circuitry 400 may also include DAC 412 to convert digital baseband signals from the transmit baseband processor 404 to analog baseband signals.

In some embodiments that communicate OFDM signals or OFDMA signals, such as through baseband processing circuitry 108A, the transmit baseband processor 404 may be configured to generate OFDM or OFDMA signals as appropriate for transmission by performing an inverse fast Fourier transform (IFFT). The receive baseband processor 402 may be configured to process received OFDM signals or OFDMA signals by performing an FFT. In some embodiments, the receive baseband processor 402 may be configured to detect the presence of an OFDM signal or OFDMA signal by performing an autocorrelation, to detect a preamble, such as a short preamble, and by performing a cross-correlation, to detect a long preamble. The preambles may be part of a predetermined frame structure for Wi-Fi communication.

Referring to FIG. 1, in some embodiments, the antennas 101 (FIG. 1) may each comprise one or more directional or omnidirectional antennas, including, for example, dipole antennas, monopole antennas, patch antennas, loop antennas, microstrip antennas or other types of antennas suitable for transmission of RF signals. In some multiple-input multiple-output (MIMO) embodiments, the antennas may be effectively separated to take advantage of spatial diversity and the different channel characteristics that may result. Antennas 101 may each include a set of phased-array antennas, although embodiments are not so limited.

Although the radio architecture 100 is illustrated as having several separate functional elements, one or more of the functional elements may be combined and may be implemented by combinations of software-configured elements, such as processing elements including digital signal processors (DSPs), and/or other hardware elements. For example, some elements may comprise one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements may refer to one or more processes operating on one or more processing elements.

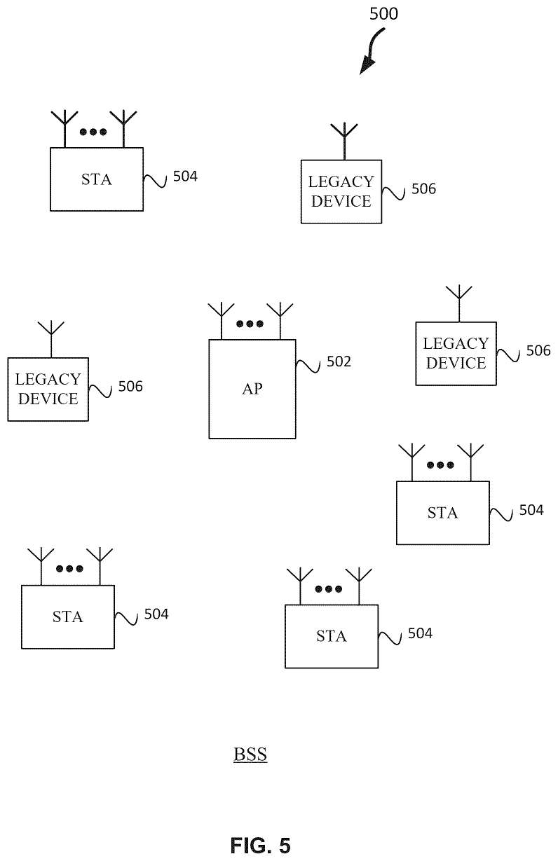

FIG. 5 illustrates a WLAN 500 in accordance with some embodiments. The WLAN 500 may comprise a basis service set (BSS) that may include an access point (AP) 502, a plurality of stations (STAs) 504, and a plurality of legacy devices 506. In some embodiments, the STAs 504 and/or AP 502 are configured to operate in accordance with IEEE 802.11be extremely high throughput (EHT) and/or high efficiency (HE) IEEE 802.11ax. In some embodiments, the STAs 504 and/or AP 520 are configured to operate in accordance with IEEE 802.11az. In some embodiments, IEEE 802.11EHT may be termed Next Generation 802.11 or a later standard. The STA 504 and AP 502 (or apparatuses of) may be configured to operate in accordance with IEEE P802.11be™/D2.2, October 2022, IEEE P802.11-REVme™/D2.0, October 2022, which are incorporated herein by reference in their entirety. The AP 502 and/or STA 504 may operate in accordance with different versions of the communication standards.

The AP 502 may be an AP operating in accordance with the IEEE 802.11 standards to transmit and receive. The AP 502 may be a base station. The AP 502 may use other communications protocols as well as the IEEE 802.11 protocol. The EHT protocol may be termed a different name in accordance with some embodiments. The IEEE 802.11 protocol may include using orthogonal frequency division multiple-access (OFDMA), time division multiple access (TDMA), and/or code division multiple access (CDMA). The IEEE 802.11 protocol may include a multiple access technique. For example, the IEEE 802.11 protocol may include space-division multiple access (SDMA) and/or multiple-user multiple-input multiple-output (MU-MIMO). There may be more than one EHT AP that is part of an extended service set (ESS). A controller (not illustrated) may store information that is common to the more than one AP 502 and may control more than one BSS, e.g., assign primary channels, colors, etc. AP 502 may be connected to the internet.

The legacy devices 506 may operate in accordance with one or more of IEEE 802.11 legacy wireless communication standards. The legacy devices 506 may be STAs or IEEE STAs. The STAs 504 may be wireless transmit and receive devices such as cellular telephone, portable electronic wireless communication devices, smart telephone, handheld wireless device, wireless glasses, wireless watch, wireless personal device, tablet, or another device that may be transmitting and receiving using the IEEE 802.11 protocol such as IEEE 802.11be or another wireless protocol.

The AP 502 may communicate with legacy devices 506 in accordance with legacy IEEE 802.11 communication techniques. In example embodiments, the H AP 502 may also be configured to communicate with STAs 504 in accordance with legacy IEEE 802.11 communication techniques.

In some embodiments, a HE or EHT frames may be configurable to have the same bandwidth as a channel. The HE or EHT frame may be a physical Layer (PHY) Protocol Data Unit (PPDU). In some embodiments, PPDU may be an abbreviation for physical layer protocol data unit (PPDU). In some embodiments, there may be different types of PPDUs that may have different fields and different physical layers and/or different media access control (MAC) layers. For example, a single user (SU) PPDU, multiple-user (MU) PPDU, extended-range (ER) SU PPDU, and/or trigger-based (TB) PPDU. In some embodiments EHT may be the same or similar as HE PPDUs.

The bandwidth of a channel may be 20 MHz, 40 MHz, or 80 MHz, 80+80 MHz, 160 MHz, 160+160 MHz, 320 MHz, 320+320 MHz, 640 MHz bandwidths. In some embodiments, the bandwidth of a channel less than 20 MHz may be 1 MHz, 1.25 MHz, 2.03 MHz, 2.5 MHz, 4.06 MHz, 5 MHz and 10 MHz, or a combination thereof or another bandwidth that is less or equal to the available bandwidth may also be used. In some embodiments the bandwidth of the channels may be based on a number of active data subcarriers. In some embodiments the bandwidth of the channels is based on 26, 52, 106, 242, 484, 996, or 2×996 active data subcarriers or tones that are spaced by 20 MHz. In some embodiments the bandwidth of the channels is 256 tones spaced by 20 MHz. In some embodiments the channels are multiple of 26 tones or a multiple of 20 MHz. In some embodiments a 20 MHz channel may comprise 242 active data subcarriers or tones, which may determine the size of a Fast Fourier Transform (FFT). An allocation of a bandwidth or a number of tones or sub-carriers may be termed a resource unit (RU) allocation in accordance with some embodiments.

In some embodiments, the 26-subcarrier RU and 52-subcarrier RU are used in the 20 MHz, 40 MHz, 80 MHz, 160 MHz and 80+80 MHz OFDMA HE PPDU formats. In some embodiments, the 106-subcarrier RU is used in the 20 MHz, 40 MHz, 80 MHz, 160 MHz and 80+80 MHz OFDMA and MU-MIMO HE PPDU formats. In some embodiments, the 242-subcarrier RU is used in the 40 MHz, 80 MHz, 160 MHz and 80+80 MHz OFDMA and MU-MIMO HE PPDU formats. In some embodiments, the 484-subcarrier RU is used in the 80 MHz, 160 MHz and 80+80 MHz OFDMA and MU-MIMO HE PPDU formats. In some embodiments, the 996-subcarrier RU is used in the 160 MHz and 80+80 MHz OFDMA and MU-MIMO HE PPDU formats. In some embodiments, two or more of the RUs are joined as an MRU.

A HE or EHT frame may be configured for transmitting a number of spatial streams, which may be in accordance with MU-MIMO and may be in accordance with OFDMA. In other embodiments, the AP 502, STA 504, and/or legacy device 506 may also implement different technologies such as code division multiple access (CDMA) 2000, CDMA 2000 1X, CDMA 2000 Evolution-Data Optimized (EV-DO), Interim Standard 2000 (IS-2000), Interim Standard 95 (IS-95), Interim Standard 856 (IS-856), Long Term Evolution (LTE), Global System for Mobile communications (GSM), Enhanced Data rates for GSM Evolution (EDGE), GSM EDGE (GERAN), IEEE 802.16 (i.e., Worldwide Interoperability for Microwave Access (WiMAX)), BlueTooth®, low-power BlueTooth®, or other technologies.

In accordance with some IEEE 802.11 embodiments, e.g., IEEE 802.11EHT/ax embodiments, a HE AP may operate as a master station which may be arranged to contend for a wireless medium (e.g., during a contention period) to receive exclusive control of the medium for a transmission opportunity (TXOP).

The AP 502 may transmit an EHT/HE trigger frame transmission, which may include a schedule for simultaneous UL/DL transmissions from STAs 504. The AP 502 may transmit a time duration of the TXOP and sub-channel information. During the TXOP, STAs 504 may communicate with the AP 502 in accordance with a non-contention based multiple access technique such as OFDMA or MU-MIMO. This is unlike conventional WLAN communications in which devices communicate in accordance with a contention-based communication technique, rather than a multiple access technique. During the HE or EHT control period, the AP 502 may communicate with STAs 504 using one or more HE or EHT frames. During the TXOP, the HE STAs may operate on a sub-channel smaller than the operating range of the AP 502. During the TXOP, legacy stations refrain from communicating. The legacy stations may need to receive the communication from the HE AP to defer from communicating.

In accordance with some embodiments, during the TXOP the STAs 504 may contend for the wireless medium with the legacy devices 506 being excluded from contending for the wireless medium during the master-sync transmission. In some embodiments the trigger frame may indicate an UL-MU-MIMO and/or UL OFDMA TXOP. In some embodiments, the trigger frame may include a DL UL-MU-MIMO and/or DL OFDMA with a schedule indicated in a preamble portion of trigger frame.

In some embodiments, the multiple-access technique used during the HE or EHT TXOP may be a scheduled OFDMA technique, although this is not a requirement. In some embodiments, the multiple access technique may be a time-division multiple access (TDMA) technique or a frequency division multiple access (FDMA) technique. In some embodiments, the multiple access technique may be a space-division multiple access (SDMA) technique. In some embodiments, the multiple access technique may be a Code division multiple access (CDMA).

The AP 502 may also communicate with legacy devices 506 and/or STAs 504 in accordance with legacy IEEE 802.11 communication techniques. In some embodiments, the AP 502 may also be configurable to communicate with STAs 504 outside the TXOP in accordance with legacy IEEE 802.11 or IEEE 802.11EHT/ax communication techniques, although this is not a requirement.

In some embodiments the STA 504 may be a “group owner” (GO) for peer-to-peer modes of operation. A wireless device may be a STA 504 or an HE AP.

In some embodiments, the STA 504 and/or AP 502 may be configured to operate in accordance with IEEE 802.11mc. In example embodiments, the radio architecture of FIG. 1 is configured to implement the STA 504 and/or the AP 502. In example embodiments, the front-end module circuitry of FIG. 2 is configured to implement the STA 504 and/or the AP 502. In example embodiments, the radio IC circuitry of FIG. 3 is configured to implement the STA 504 and/or the AP 502. In example embodiments, the base-band processing circuitry of FIG. 4 is configured to implement the STA 504 and/or the AP 502.

In example embodiments, the STAs 504, AP 502, an apparatus of the STA 504, and/or an apparatus of the AP 502 may include one or more of the following: the radio architecture of FIG. 1, the front-end module circuitry of FIG. 2, the radio IC circuitry of FIG. 3, and/or the base-band processing circuitry of FIG. 4.

In example embodiments, the radio architecture of FIG. 1, the front-end module circuitry of FIG. 2, the radio IC circuitry of FIG. 3, and/or the base-band processing circuitry of FIG. 4 may be configured to perform the methods and operations/functions described herein.

In example embodiments, the STAs 504 and/or the HE AP are configured to perform the methods and operations/functions described herein. In example embodiments, an apparatus of the STA 504 and/or an apparatus of the AP 502 are configured to perform the methods and functions described herein. The term Wi-Fi may refer to one or more of the IEEE 802.11 communication standards. AP and STA may refer to EHT/HE access point and/or EHT/HE station as well as legacy devices 506.

In some embodiments, a HE AP STA may refer to an AP 502 and/or STAs 504 that are operating as EHT APs. In some embodiments, when a STA 504 is not operating as an AP, it may be referred to as a non-AP STA or non-AP. In some embodiments, STA 504 may be referred to as either an AP STA or a non-AP. In some embodiments, the AP 502 is an AP of the AP MLD 808. In some embodiments, the STA 504 is a STA of non-AP MLD 3 809.

In some embodiments, non-AP MLD 809 advertises its millimeter wave transition delay as a capability in management frames, such as Beacon Frames, an Association Request frame, a TID-to-Link Mapping Request frame and a Probe Request frame. The AP MLD 808 responds with a response frame, such as an Association Response frame, a TID-to-Link Mapping Response frame or a Probe Response frame. In some embodiments, when a non-AP MLD 809 wants to initiate a frame exchange and/or beamforming training with the AP MLD 808 on the mmWave link, it first sends a frame in the sub-7 GHz link to notify the AP MLD 808 and suggests a target start time for the upcoming frame exchange and/or beamforming training. When determining the target start time, non-AP MLD 809 will need to take into account the transition delay to make sure the AP MLD 808 has sufficient time to activate and power on its mmWave link. These embodiments are described in more detail below.

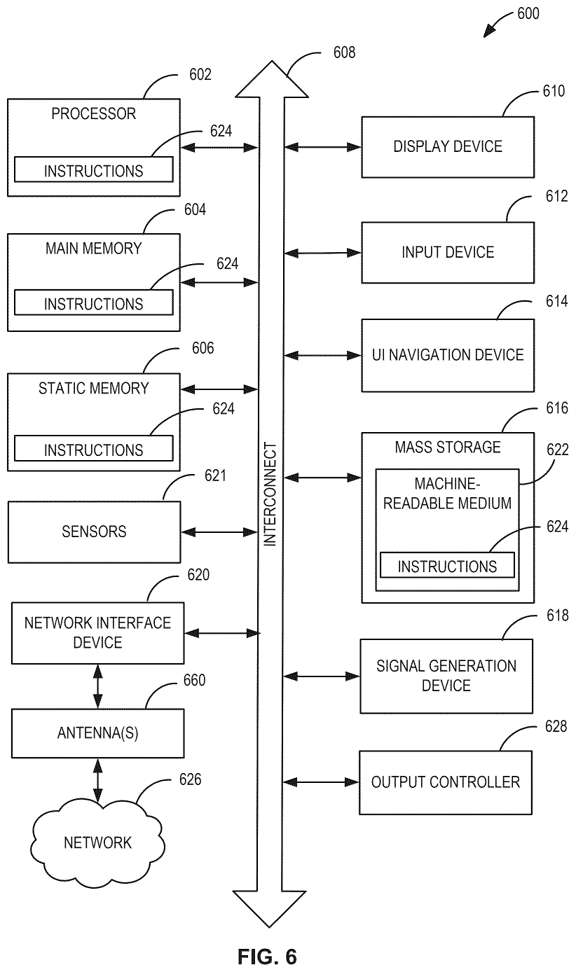

FIG. 6 illustrates a block diagram of an example machine 600 upon which any one or more of the techniques (e.g., methodologies) discussed herein may perform. In alternative embodiments, the machine 600 may operate as a standalone device or may be connected (e.g., networked) to other machines. In a networked deployment, the machine 600 may operate in the capacity of a server machine, a client machine, or both in server-client network environments. In an example, the machine 600 may act as a peer machine in peer-to-peer (P2P) (or other distributed) network environment. The machine 600 may be a HE AP, EHT STA, personal computer (PC), a tablet PC, a set-top box (STB), a personal digital assistant (PDA), a portable communications device, a mobile telephone, a smart phone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Machine (e.g., computer system) 600 may include a hardware processor 602 (e.g., a central processing unit (CPU), a graphics processing unit (GPU), a hardware processor core, or any combination thereof), a main memory 604 and a static memory 606, some or all of which may communicate with each other via an interlink (e.g., bus) 608.

Specific examples of main memory 604 include Random Access Memory (RAM), and semiconductor memory devices, which may include, in some embodiments, storage locations in semiconductors such as registers. Specific examples of static memory 606 include non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; RAM; and CD-ROM and DVD-ROM disks.

The machine 600 may further include a display device 610, an input device 612 (e.g., a keyboard), and a user interface (UI) navigation device 614 (e.g., a mouse). In an example, the display device 610, input device 612 and UI navigation device 614 may be a touch screen display. The machine 600 may additionally include a mass storage device (e.g., drive unit) 616, a signal generation device 618 (e.g., a speaker), a network interface device 620, and one or more sensors 621, such as a global positioning system (GPS) sensor, compass, accelerometer, or other sensor. The machine 600 may include an output controller 628, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.). In some embodiments the processor 602 and/or instructions 624 may comprise processing circuitry and/or transceiver circuitry.

The mass storage device 616 may include a machine readable medium 622 on which is stored one or more sets of data structures or instructions 624 (e.g., software) embodying or utilized by any one or more of the techniques or functions described herein. The instructions 624 may also reside, completely or at least partially, within the main memory 604, within static memory 606, or within the hardware processor 602 during execution thereof by the machine 600. In an example, one or any combination of the hardware processor 602, the main memory 604, the static memory 606, or the mass storage device 616 may constitute machine readable media.

Specific examples of machine readable media may include: non-volatile memory, such as semiconductor memory devices (e.g., EPROM or EEPROM) and flash memory devices; magnetic disks, such as internal hard disks and removable disks; magneto-optical disks; RAM; and CD-ROM and DVD-ROM disks.

While the machine readable medium 622 is illustrated as a single medium, the term “machine readable medium” may include a single medium or multiple media (e.g., a centralized or distributed database, and/or associated caches and servers) configured to store the one or more instructions 624.

An apparatus of the machine 600 may be one or more of a hardware processor 602 (e.g., a central processing unit (CPU), a graphics processing unit (GPU), a hardware processor core, or any combination thereof), a main memory 604 and a static memory 606, sensors 621, network interface device 620, antennas 660, a display device 610, an input device 612, a UI navigation device 614, a mass storage device 616, instructions 624, a signal generation device 618, and an output controller 628. The apparatus may be configured to perform one or more of the methods and/or operations disclosed herein. The apparatus may be intended as a component of the machine 600 to perform one or more of the methods and/or operations disclosed herein, and/or to perform a portion of one or more of the methods and/or operations disclosed herein. In some embodiments, the apparatus may include a pin or other means to receive power. In some embodiments, the apparatus may include power conditioning hardware.

The term “machine readable medium” may include any medium that is capable of storing, encoding, or carrying instructions for execution by the machine 600 and that cause the machine 600 to perform any one or more of the techniques of the present disclosure, or that is capable of storing, encoding or carrying data structures used by or associated with such instructions. Non-limiting machine readable medium examples may include solid-state memories, and optical and magnetic media. Specific examples of machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); and CD-ROM and DVD-ROM disks. In some examples, machine readable media may include non-transitory machine-readable media. In some examples, machine readable media may include machine readable media that is not a transitory propagating signal.

The instructions 624 may further be transmitted or received over a communications network 626 using a transmission medium via the network interface device 620 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi among others.

In an example, the network interface device 620 may include one or more physical jacks (e.g., Ethernet, coaxial, or phone jacks) or one or more antennas to connect to the communications network 626. In an example, the network interface device 620 may include one or more antennas 660 to wirelessly communicate using at least one of single-input multiple-output (SIMO), multiple-input multiple-output (MIMO), or multiple-input single-output (MISO) techniques. In some examples, the network interface device 620 may wirelessly communicate using Multiple User MIMO techniques. The term “transmission medium” shall be taken to include any intangible medium that is capable of storing, encoding or carrying instructions for execution by the machine 600, and includes digital or analog communications signals or other intangible medium to facilitate communication of such software.

Examples, as described herein, may include, or may operate on, logic or a number of components, modules, or mechanisms. Modules are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine readable medium. In an example, the software, when executed by the underlying hardware of the module, causes the hardware to perform the specified operations.

Accordingly, the term “module” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

Some embodiments may be implemented fully or partially in software and/or firmware. This software and/or firmware may take the form of instructions contained in or on a non-transitory computer-readable storage medium. Those instructions may then be read and executed by one or more processors to enable performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read only memory (ROM); random access memory (RAM); magnetic disk storage media; optical storage media; flash memory, etc.

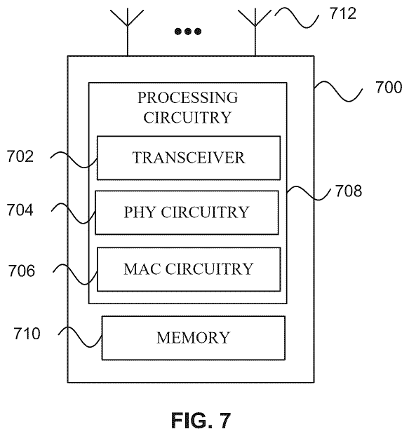

FIG. 7 illustrates a block diagram of an example wireless device 700 upon which any one or more of the techniques (e.g., methodologies or operations) discussed herein may perform. The wireless device 700 may be an HE device or HE wireless device. The wireless device 700 may be a HE STA, HE AP, and/or a HE STA or HE AP. A HE STA, HE AP, and/or a HE AP or HE STA may include some or all of the components shown in FIGS. 1-7. The wireless device 700 may be an example machine 600 as disclosed in conjunction with FIG. 6.

The wireless device 700 may include processing circuitry 708. The processing circuitry 708 may include a transceiver 702, physical layer circuitry (PHY circuitry) 704, and MAC layer circuitry (MAC circuitry) 706, one or more of which may enable transmission and reception of signals to and from other wireless devices 700 (e.g., HE AP, HE STA, and/or legacy devices 506) using one or more antennas 712. As an example, the PHY circuitry 704 may perform various encoding and decoding functions that may include formation of baseband signals for transmission and decoding of received signals. As another example, the transceiver 702 may perform various transmission and reception functions such as conversion of signals between a baseband range and a Radio Frequency (RF) range.

Accordingly, the PHY circuitry 704 and the transceiver 702 may be separate components or may be part of a combined component, e.g., processing circuitry 708. In addition, some of the described functionality related to transmission and reception of signals may be performed by a combination that may include one, any or all of the PHY circuitry 704 the transceiver 702, MAC circuitry 706, memory 710, and other components or layers. The MAC circuitry 706 may control access to the wireless medium. The wireless device 700 may also include memory 710 arranged to perform the operations described herein, e.g., some of the operations described herein may be performed by instructions stored in the memory 710.

The antennas 712 (some embodiments may include only one antenna) may comprise one or more directional or omnidirectional antennas, including, for example, dipole antennas, monopole antennas, patch antennas, loop antennas, microstrip antennas or other types of antennas suitable for transmission of RF signals. In some multiple-input multiple-output (MIMO) embodiments, the antennas 712 may be effectively separated to take advantage of spatial diversity and the different channel characteristics that may result.

One or more of the memory 710, the transceiver 702, the PHY circuitry 704, the MAC circuitry 706, the antennas 712, and/or the processing circuitry 708 may be coupled with one another. Moreover, although memory 710, the transceiver 702, the PHY circuitry 704, the MAC circuitry 706, the antennas 712 are illustrated as separate components, one or more of memory 710, the transceiver 702, the PHY circuitry 704, the MAC circuitry 706, the antennas 712 may be integrated in an electronic package or chip.

In some embodiments, the wireless device 700 may be a mobile device as described in conjunction with FIG. 6. In some embodiments the wireless device 700 may be configured to operate in accordance with one or more wireless communication standards as described herein (e.g., as described in conjunction with FIGS. 1-6, IEEE 802.11). In some embodiments, the wireless device 700 may include one or more of the components as described in conjunction with FIG. 6 (e.g., display device 610, input device 612, etc.) Although the wireless device 700 is illustrated as having several separate functional elements, one or more of the functional elements may be combined and may be implemented by combinations of software-configured elements, such as processing elements including digital signal processors (DSPs), and/or other hardware elements. For example, some elements may comprise one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements may refer to one or more processes operating on one or more processing elements.

In some embodiments, an apparatus of or used by the wireless device 700 may include various components of the wireless device 700 as shown in FIG. 7 and/or components from FIGS. 1-6. Accordingly, techniques and operations described herein that refer to the wireless device 700 may be applicable to an apparatus for a wireless device 700 (e.g., HE AP and/or HE STA), in some embodiments. In some embodiments, the wireless device 700 is configured to decode and/or encode signals, packets, and/or frames as described herein, e.g., PPDUs.

In some embodiments, the MAC circuitry 706 may be arranged to contend for a wireless medium during a contention period to receive control of the medium for a HE TXOP and encode or decode an HE PPDU. In some embodiments, the MAC circuitry 706 may be arranged to contend for the wireless medium based on channel contention settings, a transmitting power level, and a clear channel assessment level (e.g., an energy detect level).

The PHY circuitry 704 may be arranged to transmit signals in accordance with one or more communication standards described herein. For example, the PHY circuitry 704 may be configured to transmit a HE PPDU. The PHY circuitry 704 may include circuitry for modulation/demodulation, upconversion/downconversion, filtering, amplification, etc. In some embodiments, the processing circuitry 708 may include one or more processors. The processing circuitry 708 may be configured to perform functions based on instructions being stored in a RAM or ROM, or based on special purpose circuitry. The processing circuitry 708 may include a processor such as a general purpose processor or special purpose processor. The processing circuitry 708 may implement one or more functions associated with antennas 712, the transceiver 702, the PHY circuitry 704, the MAC circuitry 706, and/or the memory 710. In some embodiments, the processing circuitry 708 may be configured to perform one or more of the functions/operations and/or methods described herein.

In mmWave technology, communication between a station (e.g., the HE STA of FIG. 5 or wireless device 700) and an access point (e.g., the HE AP of FIG. 5 or wireless device 700) may use associated effective wireless channels that are highly directionally dependent. To accommodate the directionality, beamforming techniques may be utilized to radiate energy in a certain direction with certain beamwidth to communicate between two devices. The directed propagation concentrates transmitted energy toward a target device in order to compensate for significant energy loss in the channel between the two communicating devices. Using directed transmission may extend the range of the millimeter-wave communication versus utilizing the same transmitted energy in omni-directional propagation.

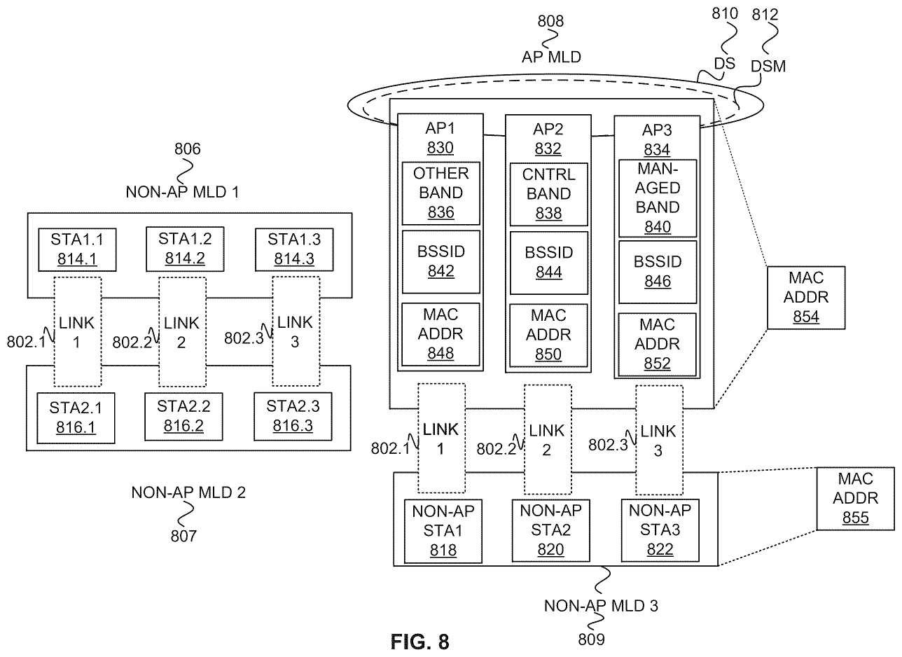

FIG. 8 illustrates multi-link devices (MLDs), in accordance with some embodiments. Illustrated in FIG. 8 is ML logical entity 1 or non-AP MLD 1 806, ML logical entity 2 or non-AP MLD 2 807, ML AP logical entity or AP MLD 808, and ML non-AP logical entity or non-AP MLD 3 809. The non-AP MLD 1 806 includes three STAs, STA1.1 814.1, STA1.2 814.2, and STA1.3 814.3 that operate in accordance with link 1 802.1, link 2 802.2, and link 3 802.3, respectively. The Links are described below. Non-AP MLD 2 807 includes STA2.1 816.1, STA2.2 816.2, and STA2.3 816.3 that operate in accordance with link 1 802.1, link 2 802.2, and link 3 802.3, respectively. In some embodiments non-AP MLD 1 806 and non-AP MLD 2 807 operate in accordance with a mesh network. Using three links enables the non-AP MLD 1 806 and non-AP MLD 2 807 to operate using a greater bandwidth and to operate more reliably as they can switch to using a different link if there is interference or if one link is superior due to operating conditions.

The distribution system (DS) 810 indicates how communications are distributed and the DS medium (DSM) 812 indicates the medium that is used for the DS 810, which in this case is the wireless spectrum.

AP MLD 808 includes AP1 830, AP2 832, and AP3 834 operating on link 1 802.1, link 2 802.2, and link 3 802.3, respectively. AP MLD 808 includes a MAC address 854 that may be used by applications to transmit and receive data across one or more of AP1 830, AP2 832, and AP3 834.

AP1 830, AP2 832, and AP3 834 include a frequency band, which are other band 836, control (CNTRL) band 838, and managed band 840, respectively.

The links 802.1, 802.2, and 802.3 may be in frequency bands such as 2.4 GHz band, 5 GHz band, 6 GHz band, 7 GHz band, 1-10 GHz, and so forth. The CNTRL band 838 is an unregulated band as described below.

In some embodiments, link 1 802.1, link 2 802.2, and link 3 802.3 may also comprise a millimeter wave band link. In these embodiments, the millimeter wave band link may be in addition to the lower band link (i.e., a sub 10 GHz link).

AP1 830, AP2 832, and AP3 834 may operate different BSSIDs, which are BSSID 842, BSSID 844, and BSSID 846, respectively. AP1 830, AP2 832, and AP3 834 include different media access control (MAC) address (addr), which are MAC adder 848, MAC addr 850, and MAC addr 852, respectively. The AP 502 is an AP MLD 808, in accordance with some embodiments. The STA 504 is a non-AP MLD 3 809, in accordance with some embodiments.

The non-AP MLD 3 809 includes non-AP STA1 818, non-AP STA2 820, and non-AP STA3 822. Each of the non-AP STAs have a MAC address (not illustrated) and the non-AP MLD 3 809 has a MAC address 855 that is different and used by application programs where the data traffic is split up among non-AP STA1 818, non-AP STA2 820, and non-AP STA3 822.

The STA 504 is a non-AP STA1 818, non-AP STA2 820, or non-AP STA3 822, in accordance with some embodiments. The non-AP STA1 818, non-AP STA2 820, and non-AP STA3 822 may operate as if they are associated with a BSS of AP1 830, AP2 832, or AP3 834, respectively, over link 1 804.1, link 2 804.2, and link 3 804.3, respectively.

A Multi-link device such as non-AP MLD 1 806 or non-AP MLD 2 807, is a logical entity that contains one or more STAs 814, 816. The non-AP MLD 1 806 and non-AP MLD 2 807 each has one MAC data service interface and primitives to the logical link control (LLC) and a single address associated with the interface, which can be used to communicate on the DSM 812. Multi-link logical entity allows STAs 814, 816 within the multi-link logical entity to have the same MAC address, in accordance with some embodiments. In some embodiments a same MAC address is used for application layers and a different MAC address is used per link 802.

In infrastructure framework, AP MLD 808, includes APs 830, 832, 834, on one side, and non-AP MLD 3 809 includes non-APs STAs 818, 820, 822 on the other side. AP MLD 808 is a ML logical entity, where each STA within the multi-link logical entity is an EHT AP, in accordance with some embodiments. Non-AP MLD 1 806, non-AP MLD 2 807, non-AP MLD 809 are multi-link logical entities, where each STA within the multi-link logical entity is a non-AP EHT STA. AP1 830, AP2 832, and AP3 834 may be operating on different bands and there may be fewer or more APs. STA1.1 814.1, STA1.2 814.2, and STA1.3 814.3 may be operating on different bands and there may be fewer or more STAs as part of the non-AP MLD 3 809.

In some embodiments, a multi-link device (MLD), 806 or 807, is a device that is a logical entity and has more than one affiliated station (STA), e.g., STAs 814, and has a single medium access control (MAC) service access point (SAP) to logical link control (LLC), which includes one MAC data service.

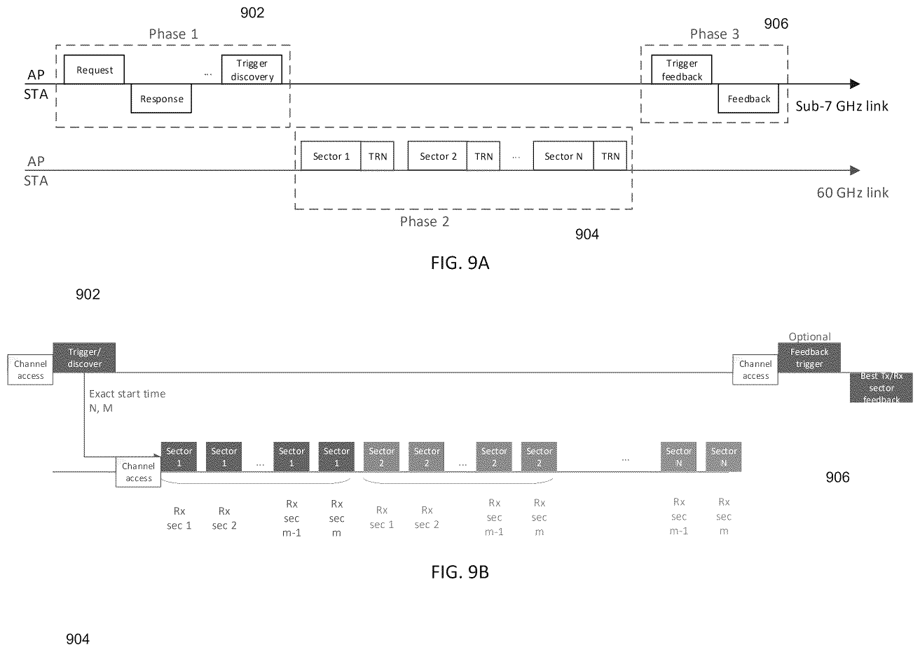

FIG. 9A illustrates Beamforming Training (Mode 1) for millimeter wave operation, in accordance with some embodiments. As shown in FIG. 9A, in phase 1 902, the AP sends frame in a lower band (i.e., a sub 7 GHz band or a sub 10 GHz band) indicating parameters for BF training (Nb of sectors, . . . ) and target start time. In phase 2 904, the AP accesses channel at a millimeter wave band and sends training signal using different sectors. This can be a MAC frame or an NDP, information (sector ID, BSSID, . . . ) can be provided in PHY or MAC. TRN may use LTF/training sequences transmitted X times, so that the receiver that locked reception in omnidirectional mode on the first part of the PPDU can use a different Rx sector for each LTF/training sequence to do Rx training. In phase 3 906, feedback (e.g., a best sector and/or a RSSI) is provided.

FIG. 9B illustrates Beamforming Training (Mode 2) for millimeter wave operation, in accordance with some embodiments. As shown in FIG. 9B for Mode 2, a sequence is used which can work without control PHY, even in case of larger antenna elements on client side (e.g., 32/64 instead of 2/4 elements). In this case, if the AP does a sector sweep, even in the best sector, the STA in omni-direction receive mode may be able to not receive it. Some embodiments combine an AP/initiator sector sweep and a STA/responder sector sweep. In these embodiments, the feedback may be communicated in lower band.

In some examples, the sequence at the upper band (e.g., 60 GHz) starts a pre-defined time after the end of the Trigger/Discover frame sent in the lower band. Basic beamforming training is performed at 60 GHz for an AP MLD that has at least an affiliated AP (AP1) operating in the 2.4 or 5 or 6 GHz band and an affiliated AP (AP2) operating in the millimeter wave band. A non-AP MLD associated or not to the AP MLD and has at least an affiliated STA (STA1) operating in the same channel as AP1 in the 2.4 or 5 or 6 GHz band and an affiliated STA (STA2) operating in the same channel as AP2 in the 60 GHz band. The AP1 initiates the basic beamforming training phase in the upper band (for STA2 and AP2) by sending a frame in the 2.4/5/6 GHz band that is broadcasted or unicasted to STA1 and indicates that a basic beamforming training will take place in the upper band with specific parameters (number of transmit sectors, number of receive sectors, . . . ). That frame may be named a Trigger/Discover but may also be named an NDP Announcement frame, a Basic Beamforming Training (BBT) Announcement frame, or any other terms. In this mode of operation, the BBT Announcement frame indicates that the start time of the BBT phase in the upper band (which corresponds to Phase 2 (see FIG. 9A)) and corresponds to the transmissions from AP2 of multiple back to back NDP or sounding frames using sector sweep) will start immediately after the end of the BBT Announcement frame. Immediately, as used here, may refer to a fixed duration defined in the standard or a duration that can be negotiated between the AP MLD and the non-AP MLD or advertised by the AP MLD. For simplicity and to reuse an often-used duration, a SIFS interval may be defined (e.g., 16 us), although the scope of the embodiments are not limited in this respect.

Following transmission of the BBT Announcement frame from AP1, the AP2 may start transmissions of the NDP or sounding frames corresponding to phase 2 SIFS time after the end of the BBT Announcement frame, with timing of this transmission to adhere to a strict timing/frequency accuracy, which may be defined in the standard. In some embodiments, the 60 GHz signal of AP2 and the 1.4/5/6 GHz signal from AP1 may be derived from the same clock to help ensure such accuracy.

The STA2 shall be available and in listen mode to receive the frames sent by AP 2 at 60 GHz. By knowing the exact time at which the first frame will be sent, STA2 implements specific mechanisms to improve packet detection.

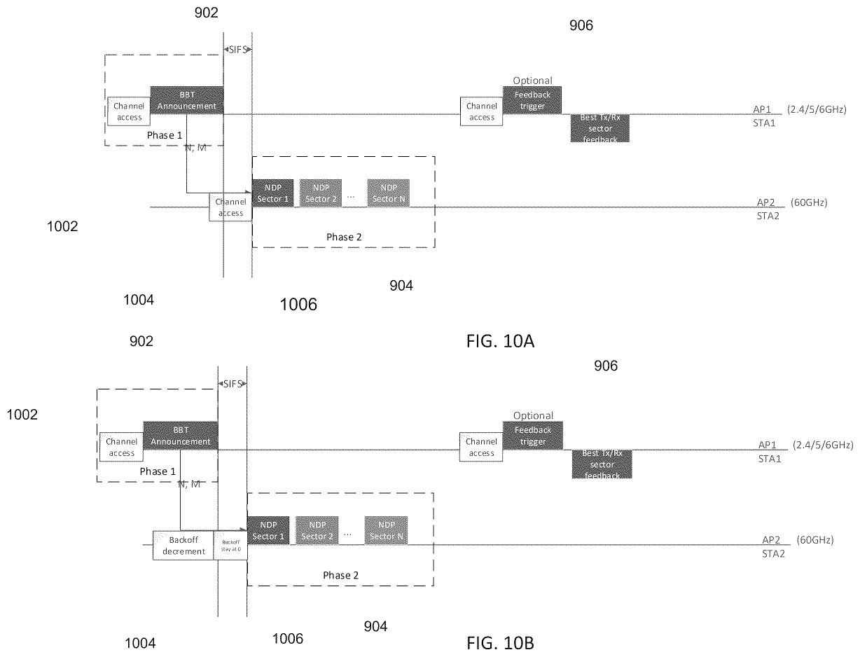

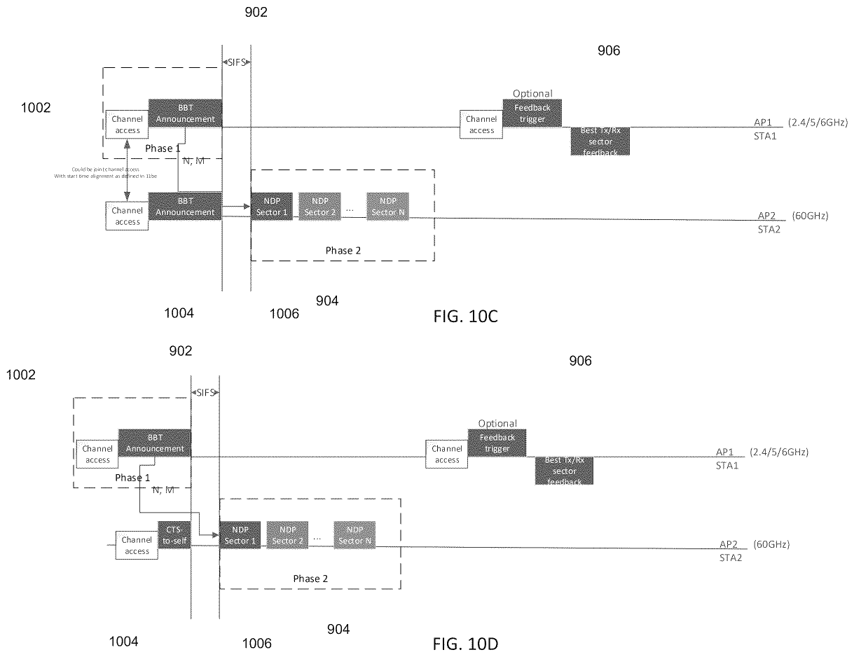

FIG. 10A illustrates a sequence with channel access right before Phase 2 904, in accordance with some embodiments. FIG. 10B illustrates a sequence with channel access right before Phase 2 904 with ability to have backoff stay at zero until the start of phase 2 904 to align with start time, in accordance with some embodiments. FIG. 10C illustrates a sequence with joint channel access at a lower band and at millimeter wave band and transmission of basic beamforming training (BBT) announcement on both links to occupy the medium at millimeter wave band and ensure alignment of phase 2 start time, in accordance with some embodiments. FIG. 10D illustrates a sequence with channel access at millimeter wave band ahead of time and transmission of CTS-to-self or other frame to occupy the medium at millimeter wave band and ensure alignment of phase 2 start time in accordance with some embodiments.

FIGS. 10A-10D illustrate beamforming training that includes phase 1 902, phase 2 904 and phase 3 906. FIGS. 10A-10D further illustrate millimeter wave transition delay 1004 for transitioning between operation in the sub 10 GHz bands and the mmWave band is provided. In these embodiments, an IMMW non-AP MLD announces its capability to transition from operation with an affiliated STA on the sub-10 GHz band to operation with another affiliated STA on the mmWave band and the amount of time that this transition will take. This time may be referred to as a Millimeter wave transition delay duration. In these embodiments, a non-AP MLD may include this information when associating with the AP MLD in the Association Request frame, and when requesting to set up a link in the mmWave band in addition to a link in the sub-10 GHz bands.

In some embodiments, the Millimeter wave transition delay may be included in a frame that enables operation in the mmWave band, for example, if the non-AP MLD is allowed to enable and disable operation in the mmWave band. In such case, a TID-to-Link Mapping concept may be used to enable/disable the mmWave link and the enablement from the non-AP MLD will be done with a TID-to-Link Mapping Request frame. In these embodiments, the Millimeter wave transition delay may be included in a Millimeter wave transition delay field in the TID-to-Link Mapping Request frame.

In accordance with some embodiments, the Millimeter wave transition delay may be the same for a transition from any link in the sub-10 GHz bands to a mmWave link. In some other embodiments, the Millimeter wave transition delay may be different for transiting to the mmWave link from each other link (a link in 2.4 GHz, link in 5 GHz, and a link in 6 GHz, . . . ).

In some embodiments, an AP MLD may also include the millimeter wave transition delay for operations that are initiated by the non-AP MLD and if an operation on the AP side is done in the mmWave link with AP power save. In these embodiments, the AP MLD may include a Millimeter wave transition delay field in some management frames that it transmits, for instance in Probe Response (especially ML Probe responses), in Association Response frames, in Beacon frames, etc. This information may be quite static, but each non-AP MLD needs to be able to get that information before association and get it once during association.

Once associated, the non-AP MLD needs to be able to get any update, if allowed, to this value. In some alternate embodiments, the Millimeter wave transition delay may be included in a TID-to-Link Mapping Response frame when the request frame is enabling the mmWave link, or any other frame that establishes operation on the mmWave link.

In some embodiments, when the AP sends a beamforming training frame (e.g., a Basic Beamforming Training frame) in a sub-10 GHz link to initiate Beamforming Training in the mmWave link. The AP may ensure that the start of the Beamforming training sequence in the mmWave link (or the start of the CCA check before the Beamforming training sequence in the mmWave link if CCA check is required) will not start before the millimeter wave transition delay of the non-AP MLD, starting from the end of the useful information carried in the BBT frame. The AP may also ensure that the end of the useful information is either the end of the User Info field if the BBT is a Trigger frame or the end of the STA Info subfield if the BBT is an NDPA frame, or the end of the security fields (if the BBT frame is protected) and of the intermediate FCS (if any), if such field is included in the BBT frame. In other words, it starts when the STA has received and has been able to parse and verify the useful information.

In some alternate embodiments, the millimeter wave transition delay may be an amount of padding that the AP may include in the BBT frame after the starting point indicated above. In some embodiments, a sub-10 GHz Transition Delay may be included to indicate an amount of time to transition back from a mmWave link to a link in the sub-10 GHz, at the end of a frame exchange in the mmWave link.

Some embodiments disclosed herein are directed to improved beamforming procedures. In these embodiments, referred to as Tx sector sweep embodiments, a BF initiator first sweeps through all of its Tx Sectors while the BF responder's Rx Sectors are frozen. In some embodiments, referred to as Rx sector sweep embodiments, a BF initiator first freezes its Tx sector while the BF responder's Rx Sectors are swept. Then, the BF initiator changes to another Tx sector and the BF responder's Rx Sectors are swept again. It repeats like until the last Tx sector. These embodiments allow the BF initiator and BF responder to negotiate and determine whether to use a Tx Sector Sweep or a Rx Sector Sweep in the BF training sequence. Furthermore, additional feedback information other than best TX/RX sector combination may be provided. These embodiments provide more flexibility for the BF initiator and BF responder to decide whether to use Tx Sector Sweep or Rx Sector Sweep during the negotiated BF procedure. The additional BF feedback information other than best Tx/Rx sector combination may be useful for the BF initiator and BF responder to determine which Tx/Rx sector to use in different scenarios.

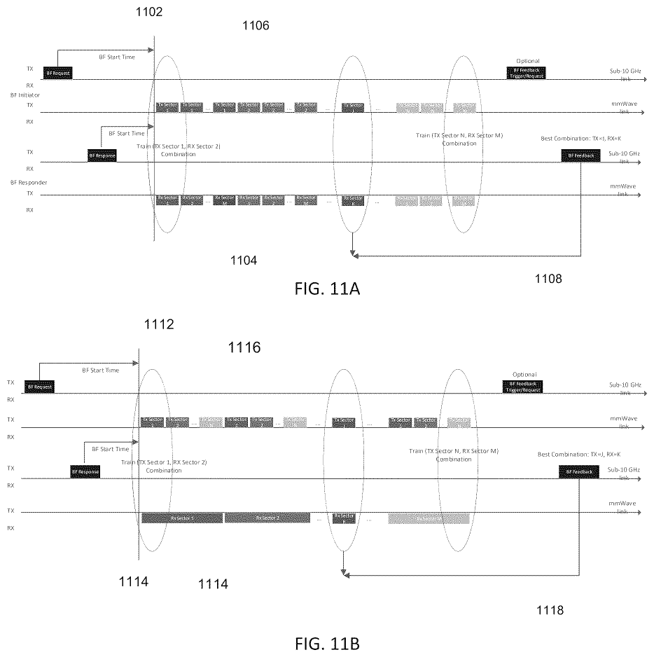

FIG. 11A illustrates a beamforming training sequence for an Rx Sector Sweep, in accordance with some embodiments. In these embodiments, the BF initiator and BF responder may have already completed a BF setup in a sub-10 GHz link and agreed on the following parameters:
The BF start time 1102 at mmWave link
The interframe spacing for all BF packets are fixed and known
Number of Tx Sectors at the BF initiator side=N, Number of Rx Sectors at the BF responder side=M
Rx Sector Sweep is used. That is, BF initiator will transmit M frames consecutively for each of its N Tx Sectors 1106. For each of the M BF frames, the BF responder will sweep its Rx Sectors 1104 from Rx Sector 1 to Rx Sector N.
After BF training completes, the BF responder sends solicited/unsolicited BF feedback 1108 to BF initiator in a sub-10 GHz link.

FIG. 11B illustrates a beamforming training sequence for a Tx Sector Sweep, in accordance with some embodiments. In these embodiments, the BF initiator and BF responder may have already completed the BF setup in a sub-10 GHz link and agreed on the following parameters:
The BF start time 1112 at mmWave link
The interframe spacing for all BF packets are fixed and known
Number of Tx Sectors at the BF initiator side=N, Number of Rx Sectors at the BF responder side=M
Tx Sector Sweep is used. That is, BF initiator will transmit N BF frames 1116 and sweep its N Tx Sectors. For each of the N BF frames, the BF responder will freeze its Rx Sector 1114. After receiving N BF frames, the BF responder will change to a different Rx Sector and repeat the process until it trains all its Rx Sectors 1114.
After BF training is completed, the BF responder sends solicited/unsolicited BF feedback 1118 to BF initiator in a sub-10 GHz link.

In accordance with these embodiments, to allow both modes (i.e., Rx sector sweep and Tx sector sweep), a BF Mode field in the BF Request and BF Response frames may be used for the BF initiator and BF responder to negotiate and agree on whether to use Rx Sector Sweep BF mode or Tx Sector Sweep BF mode in the upcoming BF procedure. In these embodiments, if the agreed BF mode is Rx Sector Sweep, then the BF procedure illustrated in FIG. 11A may be performed. If the agreed BF mode is Tx Sector Sweep, then the BF procedure illustrated in FIG. 11B may be performed.

In these embodiments, rather than only including the best Tx/Rx sector combination in the BF feedback, the BF feedback may be expanded to include more information. In these embodiments, the best L (L>1) Tx/Rx sector combinations and the corresponding RSSI/SNR information may be included in the BF Feedback frame and send it back to the BF initiator.

*Some embodiments are directed to an access point multi-link device (AP MLD) configured for Integrated Millimeter Wave (IMMW) operation. In these embodiments, the AP MLD may comprise a plurality of affiliated AP stations (APs). For IMMW operation, the AP MLD may decode a management frame received from a non-AP MLD. The frame may advertise a millimeter wave transition delay. The millimeter wave transition delay 1004 may be an amount of time for the non-AP MLD to transition from operating in a lower band to operating in an upper band. In these embodiments, the AP MLD may encode a Basic Beamforming Training (BBT) Announcement frame 1002 for transmission to the non-AP MLD. The BBT Announcement frame may be transmitted in the lower band and may indicate a start time 1006 of a beamforming training phase (i.e., Phase 2 904) for performing beamforming training in the upper band. The start time is no earlier than the end of useful information carried in the BBT Announcement frame plus the millimeter wave transition delay. In these embodiments, the lower band may be a sub 10 GHz band (i.e., a 2.4 GHz band, a 5 GHz band or a 6 GHz band) and the upper band may be a millimeter wave band (e.g., a 60 GHz band). In these embodiments, the AP MLD may take into account the millimeter wave transition delay of the non-AP MLD when determining the start time for performing the beamforming training phase. These embodiments allow the non-AP MLD sufficient time to activate a millimeter wave link prior to the beamforming training phase or prior to a frame exchange on the upper band.

In some embodiments, the useful information may comprise a User Info field when the BBT Announcement frame is a trigger frame. In some of these embodiments, the useful information may comprise a STA info subfield when the BBT Announcement frame is an NDPA frame. In some of these embodiments, the useful information may comprise one or more security fields when the BBT Announcement frame is a protected frame. In some of these embodiments, when the BBT Announcement frame is a protected frame and the one or more security fields may include an intermediate FCS if such field is included in the BBT Announcement frame.

In some embodiments, for the beamforming training phase, the AP MLD may transmit a sequence of NDP sounding frames in the upper band. In these embodiments, a first of the NDP sounding frames of the sequence is transmitted no earlier than the millimeter wave transition delay following an end of the useful information carried in the BBT Announcement frame. In these embodiments, transmission of a first of the NDP sounding frames of the sequence is transmitted at the start time, which is no earlier than the millimeter wave transition delay following an end of the useful information carried in the BBT Announcement frame. In some embodiments, AP MLD may delay transmission of the first of the NDP sounding frames by at least the millimeter wave transition delay after an end of useful information carried in the BBT Announcement frame.

In some embodiments, the management frame may be received by the AP MLD in the lower band over a link that has previously been set up in the lower band. In some of these embodiments, the management frame may comprise an Association Request frame requesting to set up a mmWave link in the upper band in addition to the link in the lower band. The Association Request frame may be encoded to include the millimeter wave transition delay.

In some embodiments, the management frame may be received by the AP MLD in the lower band over a link that has previously been set up in the lower band. In some of these embodiments, the management frame may comprise a TID-to-Link Mapping Request frame requesting enablement of a mmWave link in the upper band. The TID-to-Link Mapping Request frame may be encoded to include a field that includes the millimeter wave transition delay. In some of these embodiments, the non-AP MLD may be configured to enable and disable operation in the mmWave band using the TID-to-Link Mapping concept to enable/disable the mmWave link.

In some embodiments, the management frame may be received by the AP MLD in the lower band over a link that has previously been set up in the lower band. In some of these embodiments, the management frame may be a Probe Request frame encoded to include the millimeter wave transition delay.

In these embodiments, the non-AP MLD advertises its millimeter wave transition delay as a capability in management frames, such as an Association Request frame, a TID-to-Link Mapping Request frame and a Probe Request frame.

In some embodiments, the AP MLD may include (i.e., advertise) a millimeter wave transition delay of the AP MLD in one or more of a TID-to-Link Mapping Response frame, a Probe Response frame including multilink (ML) Probe response frames, an Association Response frame, and a Beacon frame. In these embodiments, the millimeter wave transition delay of the AP MLD may be a signalling capability for an IMMW capable MLD and may be included in an unsolicited matter.

In some embodiments, the AP MLD may decode a frame received from the non-AP MLD in the lower band indicating that the non-AP MLD wants to initiate a frame exchange and/or beamforming training with the AP MLD on the upper band. In these embodiments, the frame may include a target start time for the upcoming frame exchange and/or beamforming training. The target start time may be based at least in part on the millimeter wave transition delay of the AP MLD to allow sufficient time for the AP MLD to activate a mmWave link.

In some embodiments, the AP MLD may exchange BF Request and BF Response frames to determine (i.e., negotiate) whether to use Rx Sector Sweep BF mode or Tx Sector Sweep BF mode in the upcoming beamforming training phase with the non-AP MLD. In some of these embodiments, when the AP MLD is operating as the BF initiator, AP MLD may decode a BF feedback frame from the non-AP MLD operating as the BF responder. The BF Feedback frame may indicate more than one TX/RX sector combination and include corresponding RSSI/SNR information.

In some embodiments, as part of the exchange of BF Request and BF Response frames, the BF initiator and the BF responder may determine a number of Tx sectors (N) and a number of Rx sectors (M) to be trained in the beamforming training phase. In these embodiments, during the BF Request and BF response frame exchange, the BF initiator and BF responder negotiate and agree on the number of Tx sectors (N) and the number of Rx sectors (M) to be trained in the upcoming Beamforming sequence.

In some embodiments, the Tx Sector Sweep BF mode may comprise the BF initiator sweeping (i.e., transmitting BF training frames) through each of the TX sectors while the BF responder receives through one RX sector (see FIG. 11B). In these embodiments, the Rx Sector Sweep BF mode may comprise the BF initiator transmitting through one TX sector at a time while the BF responder sweeps (i.e., receives BF training frames) through the RX sectors (see FIG. 11A).

In some embodiments, the Tx Sector Sweep BF mode may comprise the BF initiator transmitting N BF frames sweeping through N Tx Sectors. In these embodiments, for each of the N BF frames, the BF responder will receive through one Rx Sector at a time (i.e., freeze its Rx Sector) until all Rx sectors are trained. In these embodiments, the Rx Sector Sweep BF may comprise the BF initiator transmitting M frames consecutively for each of its N Tx Sectors and for each of the M BF frames during which time the BF responder sweeping through the Rx Sectors (i.e., from Rx Sector 1 to Rx Sector N).

In these embodiments, for a Tx Sector Sweep BF, the BF initiator may transmit N BF frames and sweep its N Tx Sectors. For each of the N BF frames, the BF responder will freeze its Rx Sector. After receiving N BF frames, the BF responder may change to a different Rx Sector and repeat the process until it trains all its Rx Sectors. For the Rx Sector Sweep BF, the BF initiator may transmit M frames consecutively for each of its N Tx Sectors. For each of the M BF frames, the BF responder will sweep its Rx Sectors from Rx Sector 1 to Rx Sector N.

In some embodiments, the millimeter wave transition delay may be a time for transitioning the non-AP MLD from any of the 2.4 GHz band, the 5 GHz band, and the 6 GHz band to the mmWave band. In these embodiments, the millimeter wave transition delay may be the same for transitioning between any link in the lower band to the upper band.

In some embodiments, the millimeter wave transition delay may comprise one or more of a first millimeter wave transition delay indicating a time for transitioning the non-AP MLD from the 2.4 GHz band to the mmWave band, a second millimeter wave transition delay indicating a time for transitioning the non-AP MLD from the 5 GHz band to the mmWave band, and a third millimeter wave transition delay indicating a time for transitioning the non-AP MLD from the 6 GHz band to the mmWave band. In these embodiments, the millimeter wave transition delay may be different for transitioning between the different bands of the lower band to the upper band.

Some embodiments are directed to a method performed by an access point multi-link device (AP MLD) configured for Integrated Millimeter Wave (IMMW) operation. In these embodiments, the method may include decoding a management frame received from a non-AP MLD, the frame indicating or advertising a millimeter wave transition delay. The method may also include encoding a Basic Beamforming Training (BBT) Announcement frame for transmission to the non-AP MLD. The BBT Announcement frame may be transmitted in the lower band and may indicate a start time of a beamforming training phase (i.e., Phase 2) for performing beamforming training in the upper band. In these embodiments, the start time is no earlier than an end of useful information carried in the BBT Announcement frame plus the millimeter wave transition delay.

Some embodiments are directed to an access point (AP) configured for Integrated Millimeter Wave (IMMW) operation. In these embodiments, the AP may decode a management frame received from a non-AP station (STA) indicating a millimeter wave transition delay. The millimeter wave transition delay may be an amount of time for the non-AP STA to transition from operating in a lower band to operating in an upper band. The AP may encode a Basic Beamforming Training (BBT) Announcement frame for transmission to the non-AP STA. The BBT Announcement frame may be transmitted in the lower band and may indicate a start time of a beamforming training phase (i.e., Phase 2) for performing beamforming training in the upper band. In these embodiments, the start time may be no earlier than an end of useful information carried in the BBT Announcement frame plus the millimeter wave transition delay.

The Abstract is provided to comply with 37 C.F.R. Section 1.72(b) requiring an abstract that will allow the reader to ascertain the nature and gist of the technical disclosure. It is submitted with the understanding that it will not be used to limit or interpret the scope or meaning of the claims. The following claims are hereby incorporated into the detailed description, with each claim standing on its own as a separate embodiment.

What is claimed is:

1. An apparatus for an access point multi-link device (AP MLD) configured for Integrated Millimeter Wave (IMMW) operation, the AP MLD comprising a plurality of affiliated AP stations (APs) configured by processing circuitry and memory, wherein for IMMW operation, the processing circuitry is configured to:
decode a management frame received from a non-AP MLD, the frame indicating a millimeter wave transition delay, the millimeter wave transition delay being an amount of time for the non-AP MLD to transition from operating in a lower band to operating in an upper band; and
encode a Basic Beamforming Training (BBT) Announcement frame for transmission to the non-AP MLD, the BBT Announcement frame being transmitted in the lower band, the BBT Announcement frame indicating a start time of a beamforming training phase for performing beamforming training in the upper band,
wherein the start time is no earlier than an end of useful information carried in the BBT Announcement frame plus the millimeter wave transition delay,
wherein the lower band is a sub 10 GHz band comprising one or more of a 2.4 GHz band, a 5 GHz band and a 6 GHz band; and
wherein the upper band is a millimeter wave band.

2. The apparatus of claim 1 wherein the useful information comprises a User Info field when the BBT Announcement frame is a trigger frame,
wherein the useful information comprises a STA info subfield when the BBT Announcement frame is an NDPA frame, and
wherein the useful information comprises one or more security fields when the BBT Announcement frame is a protected frame.

3. The apparatus of claim 2, wherein for the beamforming training phase, the processing circuitry is to configure the AP MLD to transmit a sequence of NDP sounding frames in the upper band,
wherein transmission of a first of the NDP sounding frames of the sequence is transmitted no earlier than the millimeter wave transition delay following the useful information carried in the BBT Announcement frame.

4. The apparatus of claim 3, wherein the management frame is received in the lower band over a link that has previously been setup in the lower band, and
wherein the management frame comprises an Association Request frame requesting to setup a millimeter wave link in the upper band in addition to the link in the lower band, the Association Request frame encoded to include the millimeter wave transition delay.

5. The apparatus of claim 3, wherein the management frame is received in the lower band over a link that has previously been setup in the lower band, and
wherein the management frame comprises a TID-to-Link Mapping Request frame requesting enablement of a millimeter wave link in the upper band, the TID-to-Link Mapping Request frame encoded to include a field that includes the millimeter wave transition delay.

6. The apparatus of claim 3, wherein the management frame is received in the lower band over a link that has previously been setup in the lower band, and
wherein the management frame comprises a Probe Request frame encoded to include the millimeter wave transition delay.

7. The apparatus of claim 3, wherein the processing circuitry is further configured to include a millimeter wave transition delay of the AP MLD in one or more of a TID-to-Link Mapping Response frame, a Probe Response frame, an Association Response frame, and a Beacon frame.

8. The apparatus of claim 7, wherein the AP MLD is configured to decode a frame received from the non-AP MLD in the lower band, the frame indicating that the non-AP MLD wants to initiate a frame exchange and/or beamforming training with the AP MLD on the upper band,
wherein the frame includes a target start time for the frame exchange and/or beamforming training, the target start time based at least in part on the millimeter wave transition delay of the AP MLD to allow sufficient time for the AP MLD to activate a millimeter wave link.

9. The apparatus of claim 3, wherein the AP MLD is configured to exchange BF Request and BF Response frames to determine whether to use Rx Sector Sweep BF mode or Tx Sector Sweep BF mode in the beamforming training phase with the non-AP MLD, and
wherein, when the AP MLD is operating as a BF initiator, the processing circuitry is configured to decode a BF feedback frame from the non-AP MLD operating as a BF responder, the BF Feedback frame indicates more than one TX/RX sector combination and including corresponding RSSI/SNR information, wherein as part of the exchange of BF Request and BF Response frames, the BF initiator and the BF responder determine a number of Tx sectors (N) and a number of Rx sectors (M) to be trained in the beamforming training phase.

10. The apparatus of claim 9, wherein the Tx Sector Sweep BF mode comprises the BF initiator sweeping through each of TX sectors while the BF responder receives through one RX sector, and
wherein the Rx Sector Sweep BF mode comprises the BF initiator transmitting through one TX sector while the BF responder sweeps through the RX sectors.

11. The apparatus of claim 9, wherein the Tx Sector Sweep BF mode comprises the BF initiator transmitting N BF frames sweeping through N Tx Sectors, wherein for each of the N BF frames, the BF responder will receive through one Rx Sector at a time until all Rx sectors are trained, and
wherein the Rx Sector Sweep BF comprises the BF initiator transmitting M frames consecutively for each of its N Tx Sectors and for each of the M BF frames during which time the BF responder sweeping through the Rx Sectors.

12. The apparatus of claim 3, wherein the millimeter wave transition delay comprises a time for transitioning the non-AP MLD from any of the 2.4 GHz band, the 5 GHz band, and the 6 GHz band to the millimeter wave band.

13. The apparatus of claim 3, wherein the millimeter wave transition delay comprises one or more of a first millimeter wave transition delay indicating a time for transitioning the non-AP MLD from the 2.4 GHz band to the millimeter wave band, a second millimeter wave transition delay indicating a time for transitioning the non-AP MLD from the 5 GHz band to the millimeter wave band, and a third millimeter wave transition delay indicating a time for transitioning the non-AP MLD from the 6 GHz band to the millimeter wave band.

14. A method performed by processing circuitry of an access point multi-link device (AP MLD) configured for Integrated Millimeter Wave (IMMW) operation, the method comprising:
decoding a management frame received from a non-AP MLD, the frame indicating a millimeter wave transition delay, the millimeter wave transition delay being an amount of time for the non-AP MLD to transition from operating in a lower band to operating in an upper band; and
encoding a Basic Beamforming Training (BBT) Announcement frame for transmission to the non-AP MLD, the BBT Announcement frame being transmitted in the lower band, the BBT Announcement frame indicating a start time of a beamforming training phase for performing beamforming training in the upper band,
wherein the start time is no earlier than an end of useful information carried in the BBT Announcement frame plus the millimeter wave transition delay,
wherein the lower band is a sub 10 GHz band comprising one or more of a 2.4 GHz band, a 5 GHz band and a 6 GHz band; and
wherein the upper band is a millimeter wave band.

15. The method of claim 14, wherein the useful information comprises a User Info field when the BBT Announcement frame is a trigger frame,
wherein the useful information comprises a STA info subfield when the BBT Announcement frame is an NDPA frame, and
wherein the useful information comprises one or more security fields when the BBT Announcement frame is a protected frame.

16. The method of claim 15, wherein for the beamforming training phase, the method comprising configuring the AP MLD to transmit a sequence of NDP sounding frames in the upper band,
wherein transmission of a first of the NDP sounding frames of the sequence is transmitted no earlier than the millimeter wave transition delay following the useful information carried in the BBT Announcement frame.

17. The method of claim 16, wherein the management frame is received in the lower band over a link that has previously been setup in the lower band, and
wherein the management frame comprises an Association Request frame requesting to setup a millimeter wave link in the upper band in addition to the link in the lower band, the Association Request frame encoded to include the millimeter wave transition delay.

18. An access point (AP) configured for Integrated Millimeter Wave (IMMW) operation, the AP comprising processing circuitry and memory, wherein for IMMW operation, the processing circuitry is configured to:
decode a management frame received from a non-AP station (STA), the frame indicating a millimeter wave transition delay, the millimeter wave transition delay being an amount of time for the non-AP STA to transition from operating in a lower band to operating in an upper band;
encode a Basic Beamforming Training (BBT) Announcement frame for transmission to the non-AP STA, the BBT Announcement frame being transmitted in the lower band, the BBT Announcement frame indicating a start time of a beamforming training phase for performing beamforming training in the upper band,
wherein the start time is no earlier than an end of useful information carried in the BBT Announcement frame plus the millimeter wave transition delay,
wherein the lower band is a sub 10 GHz band comprising one or more of a 2.4 GHz band, a 5 GHz band and a 6 GHz band; and
wherein the upper band is a millimeter wave band.

19. The AP of claim 18, wherein the useful information comprises a User Info field when the BBT Announcement frame is a trigger frame,
wherein the useful information comprises a STA info subfield when the BBT Announcement frame is an NDPA frame, and
wherein the useful information comprises one or more security fields when the BBT Announcement frame is a protected frame.

20. The AP of claim 18, wherein for the beamforming training phase, the processing circuitry is to configure the AP to transmit a sequence of NDP sounding frames in the upper band,
wherein transmission of a first of the NDP sounding frames of the sequence is transmitted no earlier than the millimeter wave transition delay following an end of the useful information carried in the BBT Announcement frame.
